(19) United States
(12) Patent Application Publication
(10) Pub. No.: US 2008/0230987 A1
(43) Pub. Date: Sep. 25, 2008

(54) Gaming control holder

(76) Inventor: Perry L. Jackson, Chicago, IL (US)

Correspondence Address: Paul E Schaafsma, NovusIP, LLC, Suite 221, 521 West Superior Street, Chicago, IL, 60610-3135, US

(21) Appl. No.: 11/725,924

(22) Filed: Mar. 20, 2007

(51) Int. Cl. A63F 13/02

(52) U.S. Cl. 273/148 B

(57) ABSTRACT

A holster for a game controller is provided. The holster includes a support surface adapted to be mountable to a surface. A pair of opposing ends is connected to the support surface. The opposing ends are connected by bridge, with the opposing ends and the bridge defining a game controller rest area. The game controller rest area removably secures the game controller between the opposing ends. In one embodiment, an inwardly protruding section can be provided on at least one of the opposite ends such that the game controller rest area removably secures the game controller between the opposing ends. In another embodiment, the distance between the opposite ends can narrow as the opposite ends extend away from the bridge, such that the game controller rest area removably secures the game controller between the opposing ends.

### FIELD OF THE INVENTION

The present invention relates to a holster for a controller for a video game and the like.

### BACKGROUND OF THE INVENTION

Typically, video games are operated on a device with a screen or monitor for displaying the game such as a television or computer with an operating unit. The controls for the game are usually connected to the operating unit by electrical wire with a plug that is received into the appropriate receiving outlet on an operating unit. The connecting wire typically may be three to five feet in length. More recently, game controls have been increasingly utilizing wireless connectively.

When not in use, the game control may be left near the television or monitor or operating unit with the wire connecting the game control to operating unit in a random position where it may entangle objects. This is not only unsightly, but may be a hazard if the game control is left on a floor in front of a television where a passerby might become entangled in the wire. If the game control is stored on the top of the television with the loose wire overhanging the television, the game control could fall off the television with the slightest provocation or movement.

And after using or playing with the game controller, children often leave the game controller scattered on the floor where they are unsightly and also subject to damage. With the increased use of wireless controls, the chances of misplacing or loosing entirely the game controller has become significant.

Thus, there is a need in the electronic game industry for a game controller holder for storing a game controller. There is a further need for game controller holder that can be mounted on a vertical wall or the side wall of a television or monitor to provide a secure, immovable storage place for the game control unit.

### SUMMARY OF THE INVENTION

A holster for a game controller in accordance with the principles of the present invention can be mounted on a vertical wall or the side wall of a television or monitor to provide a secure, immovable storage place for the game control unit. The holster includes a support surface adapted to be mountable to a surface. A pair of opposing ends is connected to the support surface. The opposing ends are connected by bridge, with the opposing ends and the bridge defining a game controller rest area. The game controller rest area removably secures the game controller between the opposing ends. In one embodiment, an inwardly protruding section can be provided on at least one of the opposite ends such that the game controller rest area removably secures the game controller between the opposing ends. In another embodiment, the distance between the opposite ends can narrow as the opposite ends extend away from the bridge, such that the game controller rest area removably secures the game controller between the opposing ends.

### BRIEF DESCRIPTION OF THE DRAWINGS

The foregoing aspects and many of the advantages of the present invention will be more readily appreciated as the same becomes better understood by reference to the following detailed description, when taken in conjunction with the accompanying drawings, wherein:

FIG. 1 is a perspective view showing a game controller in a holster for a game controller in accordance with the principles of the present invention.

FIG. 2 is a perspective view showing the holster for a game controller of FIG. 1.

FIG. 3 is an overhead view showing the holster for a game controller of FIG. 1.

FIG. 4 is side elevation cut-away view showing the holster for a game controller of FIG. 1.

FIG. 5 is a perspective view showing a game controller in another embodiment of a holster for a game controller in accordance with the principles of the present invention.

FIG. 6 is a perspective view showing the holster for a game controller of FIG. 5.

FIG. 7 is a perspective view showing a game controller in another embodiment of a holster for a game controller in accordance with the principles of the present invention.

FIG. 8 is a perspective view showing the holster for a game controller of FIG. 7.

FIG. 9 is a perspective view showing a game controller in another embodiment of a holster for a game controller in accordance with the principles of the present invention.

FIG. 10 is a perspective view showing the holster for a game controller of FIG. 9.

FIG. 11 is a perspective view showing a game controller in another embodiment of a holster for a wireless game controller in accordance with the principles of the present invention.

FIG. 12 is a perspective view showing the holster for the wireless game controller of FIG. 11.

### DETAILED DESCRIPTION OF THE INVENTION

While an exemplary embodiment of the invention has been illustrated and described, it will be appreciated that various changes can be made therein without departing from the spirit and scope of the invention.

This invention relates to a holster for a game controller. While different game manufacturers employ different shaped game controllers, such game controllers typically employ common features. The game controllers are generally of the type having housing with control keys on the top surface of the housing for activating and playing a game viewed on a monitor. A joystick may also be provided on the top surface of the housing for playing games. And housing for the game controller is typically ergonomically designed for a user's hands.

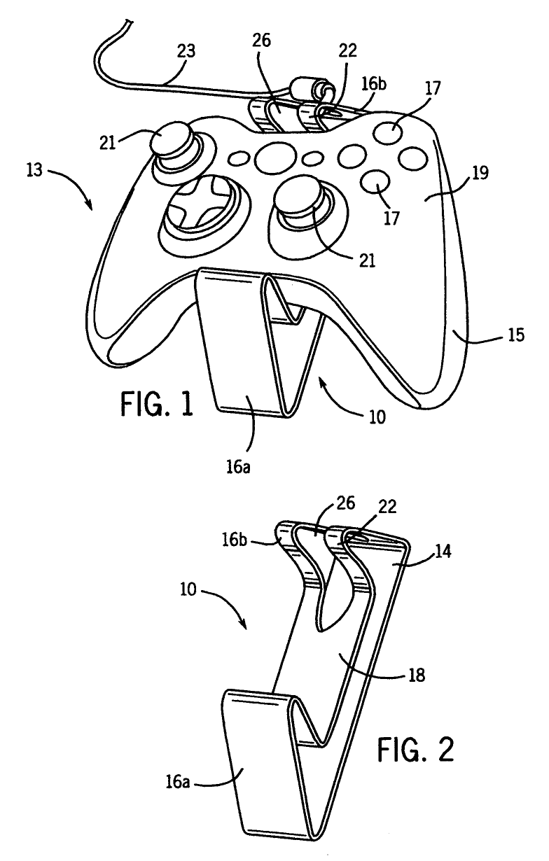

Referring now to FIG. 1, a perspective view of a game controller 13 in a holster for a game controller 10 in accordance with the principles of the present invention is seen. The game controller 13 includes housing 15 with various control keys 17 on the top surface 19 of the housing 15 for activating and playing a game viewed on a monitor. At least one joystick 21 can also be provided on the top surface 19 of the housing 15 for playing games. While the game controller 13 of FIG. 1 includes a cord 23 that is connectable to a game operating unit, the holster 10 for a game controller in accordance with the principles of the present invention can be used with corded or wireless game controllers, and is particularly useful with wireless game controllers.

FIG. 2 is a perspective view showing the holster 10 for a game controller of FIG. 1 with the game controller removed. The holster 10 includes a support surface 14 that can be mounted to a vertical surface such as the side of a television armoire for example or a horizontal surface such as the top of a television for example. The support surface can be mounted by known means such as for example an adhesive secured to the lower surface or by providing an aperture through which a screw can extend.

Referring to FIG. 4 in combination with FIG. 2, the holster 10 has two opposing ends 16a, 16b that are connected by bridge 18. Typically, the opposing ends of the game controller are held by the user for operation and are thus ergonomically designed with extensions to accommodate the hands of a user. The bridge 18 is sized for securely fitting the game controller between the hand accommodating extensions.

In more detail, the bridge 18 is contained between the opposing ends 16a, 16b. The opposing ends 16a, 16b extend generally upwardly from the bridge 18. Importantly, as best see in FIG. 4 the upward extensions of the opposing ends 16a, 16b is preferably designed to slightly narrow the distance (d) between the opposing ends 16a, 16b at this distance (d) extends away from the bridge 18. In addition, in one embodiment the holster can preferably be made of a material that allows a slight resiliency in the holster 10. As seen in FIG. 1, the slight narrowing of the distance (d) between the opposing ends 16a, 16b combined with a material that allows a slight resiliency in the holster 10 enables the holster 10 to removably secure the game controller 13 in the holster 10. In various examples, the holster 10 can be made of lightweight plastic, a resilient metal or even a wood that is resilient such as a laminate, and the like. Thus, when the holster 10 is secured on a vertical surface, the game controller 13 is secured from falling if the vertical surface is slightly jarred. In one embodiment, at least one of the upward extensions of the opposing ends 16a, 16b can include an inwardly protruding section 22.

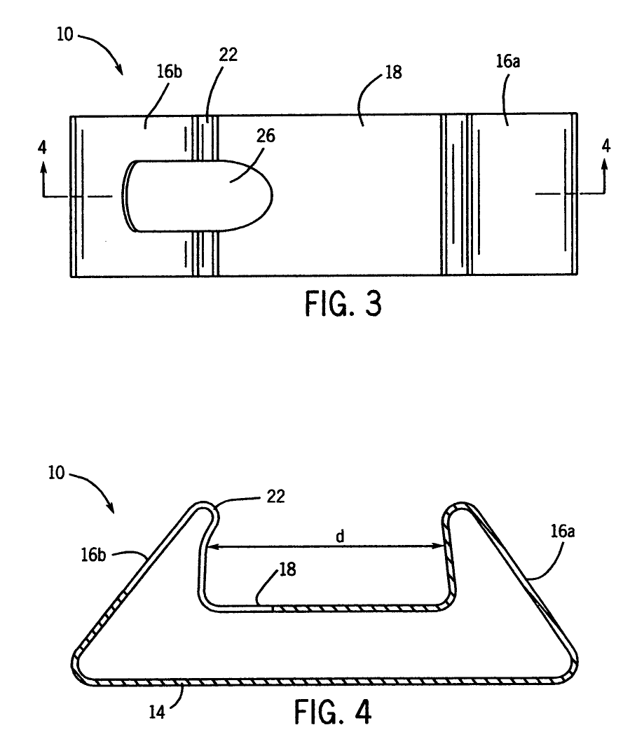

As previously described, a holster for a game controller in accordance with the principles of the present invention can be used with corded or wireless game controllers. As the game controller 13 of FIG. 1 includes a cord 23, the holster 10 of FIGS. 1-4 defines a cord accommodating aperture 26 defined in one of the opposing ends 16a, 16b. In the event a wireless controller is used this aperture 26 can be eliminated, although one of the opposing ends 16a, 16b may be required to be adopted to accommodate the wireless housing.

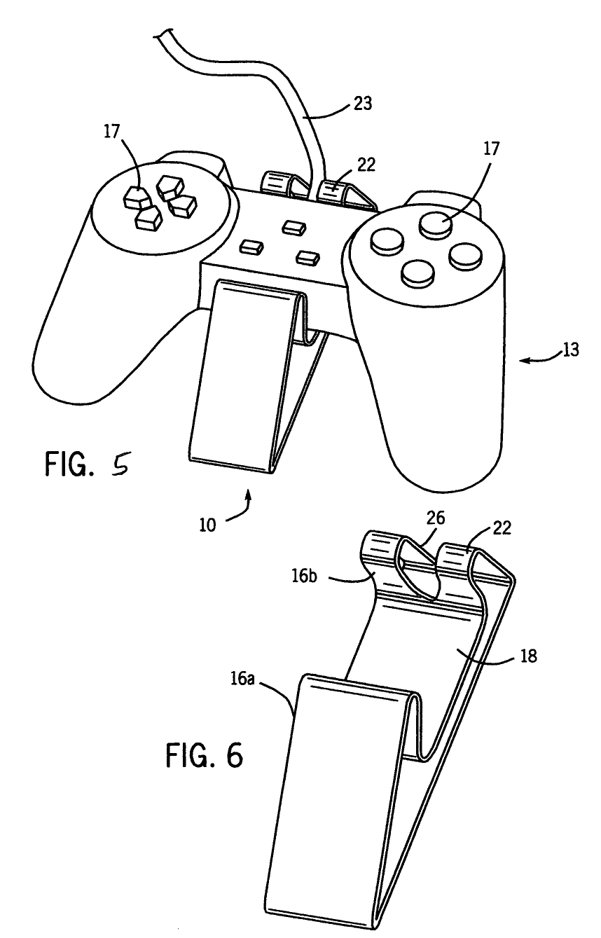

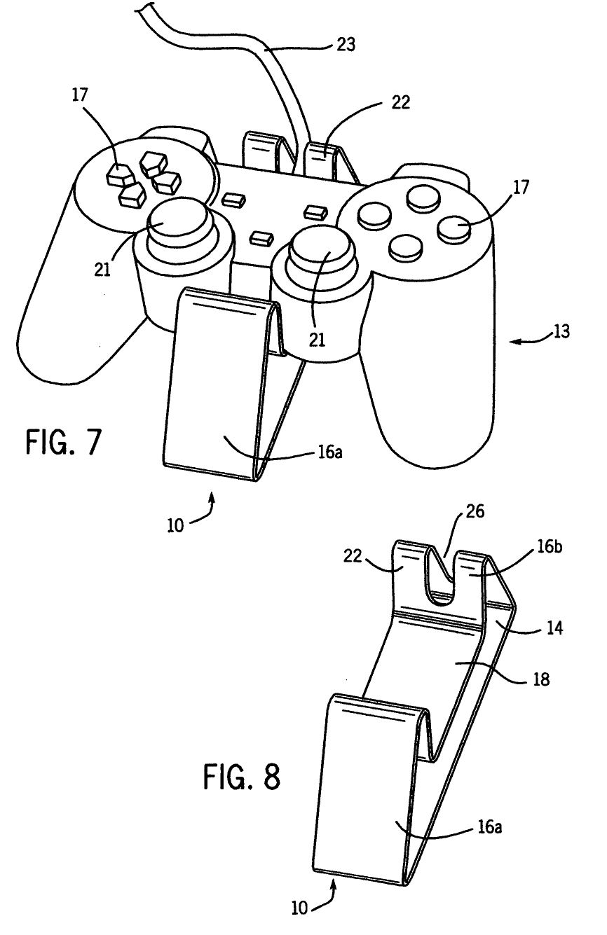

As previously described, different game manufacturers employ different shaped game controllers. For instance, the example game controller 13 in FIGS. 1-4 is the game controller for the Xbox 360 controller available from Microsoft Corporation, Redmond, Wash. Referring now to FIGS. 5 and 6, a different game controller 13 is seen in a holster for a game controller 10 in accordance with the principles of the present invention. Such game controllers typically employ common features. The game controllers are generally of the type having housing with control keys on the top surface of the housing for activating and playing a game viewed on a monitor. A joystick may also be provided on the top surface of the housing for playing games. And housing for the game controller is typically ergonomically designed for a user's hands. Thus, in FIGS. 5 and 6, common elements are given common reference numbers. The example game controller 13 in FIGS. 5 and 6 is the game controller for the Playstation controller available from Sony Computer Entertainment, Inc., Tokyo, Japan. Similarly, the example game controller 13 in FIGS. 7 and 8 is the game controller for the Playstation II controller available from Sony Computer Entertainment, Inc.

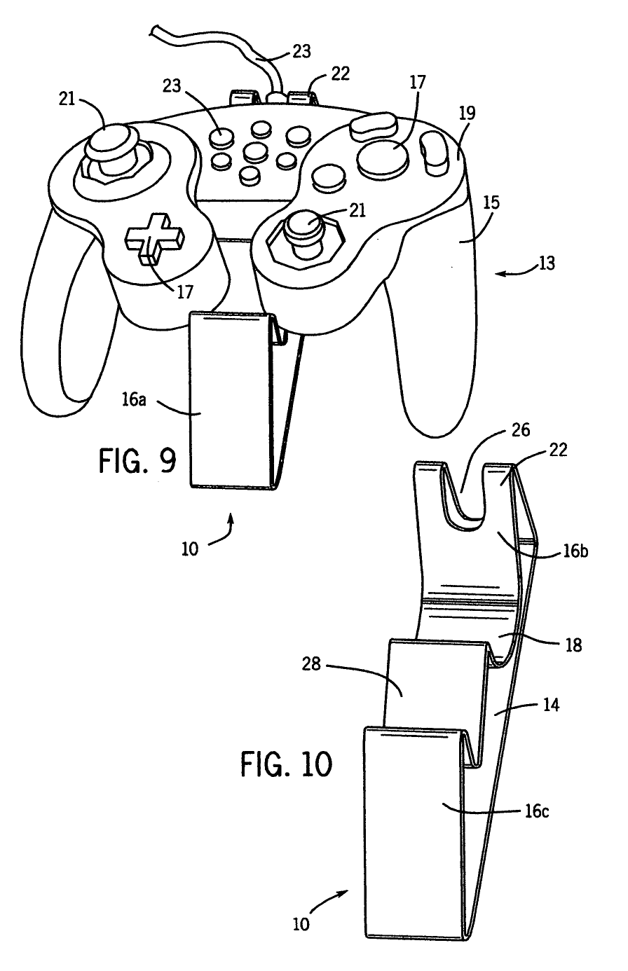

Typically, even gaming controller having more complicated functionality employ common features. For example, gaming controllers for the lodging industry also typically need functionality related to the purchase of the gaming features. Referring to FIGS. 9 and 10, a holster 10 for a game controller 13 for the LodgeNet System available from LodgeNet Entertainment Corporation, Sioux Falls, S. Dak. and made by Nintendo Company, Limited, Kyoto, Japan is seen. Again, in FIGS. 9 and 10 common elements are given common reference numbers. In addition, the game controller 13 of FIG. 9 includes various control keys 23 on the top surface 19 of the housing 15 for selecting and purchasing gaming features. In FIGS. 9 and 10, because of the shape of the bottom of the game controller 13, the bridge 18 includes an upwardly extending member 28 adapted to reflect the shape of the shape of the bottom of the game controller 13. Nevertheless, the narrowing of the distance (d) between the opposing ends 16a, 16b combined with a material that allows a slight resiliency in the holster 10 of FIGS. 9 and 10 enables the holster 10 to removably secure the game controller 13 in the holster 10.

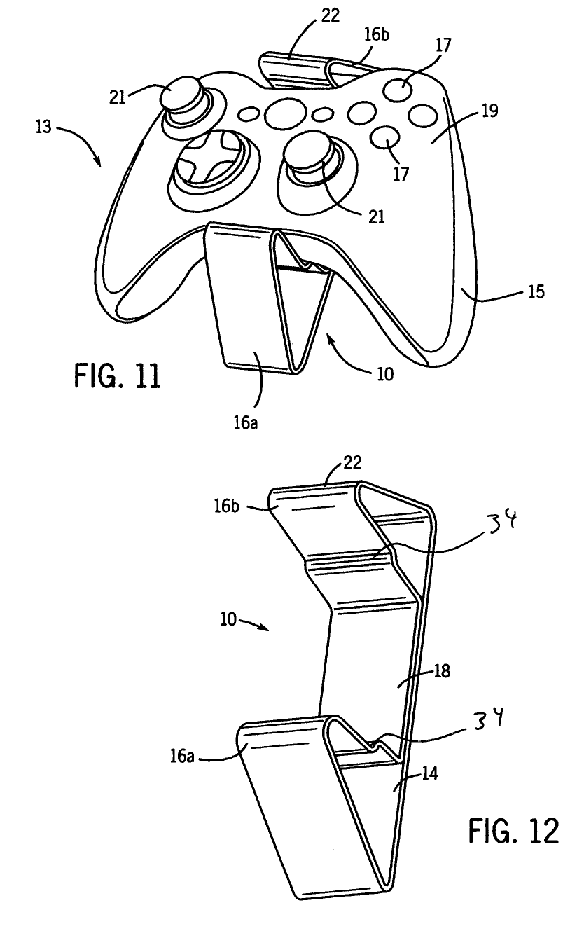

As previously described, game controls have been increasingly utilizing wireless connectively. With this increased use of wireless controls, the chances of misplacing or loosing entirely the game controller has become significant. Referring to FIGS. 11 and 12, a wireless game controller for the Xbox 360 controller available from Microsoft Corporation, Redmond, Wash. is seen. Because of the shape of the bottom of the game controller 13 includes the wireless control housing, as compared to the holster for the wired game controller for the Xbox 360 controller described in connection with FIGS. 1-4 above, the holster 10 in FIGS. 11 and 12 include a stepped portion 34 to accommodate the wireless control housing. Nevertheless, the holster 10 in FIGS. 11 and 12 employs the principles of the present invention.

Thus, it is seen that the present invention provides many advantages. A holster for a game controller in accordance with the principles of the present invention can be mounted on a vertical wall or the side wall of a television or monitor to provide a secure storage place for the game controller.

While the invention has been described with specific embodiments, other alternatives, modifications and variations will be apparent to those skilled in the art. Accordingly, it will be intended to include all such alternatives, modifications and variations set forth within the spirit and scope of the appended claims.

What is claimed is:

1. A holster for a game controller comprising:
a support surface adapted to be mountable to a surface;
opposing ends connected to the support surface, the opposing ends being connected by bridge, the opposing ends and bridge defining a game controller rest area; and
the game controller rest area removably securing the game controller between the opposing ends.

2. The holster for a game controller of claim 1 further wherein the support surface is adapted to be mountable to a surface by an adhesive secured to a lower surface of the support surface.

3. The holster for a game controller of claim 1 further wherein the support surface is adapted to be mountable to a surface by defining an aperture through which a screw can extend.

4. The holster for a game controller of claim 1 further wherein the game controller rest area accommodates the game controller between hand accommodating extensions on the game controller.

5. The holster for a game controller of claim 1 further wherein the game controller rest area removably secures the game controller between the opposing ends by narrowing the distance between the opposite ends as the opposite ends extend away from the bridge.

6. The holster for a game controller of claim 1 further wherein the game controller rest area removably secures the game controller between the opposing ends by providing an inwardly protruding section on at least one of the opposite ends.

7. The holster for a game controller of claim 1 further wherein the holster defines a cord accommodating aperture in one of the opposing ends.

8. The holster for a game controller of claim 1 further wherein the bridge is defined by the shape of the game controller.

9. The holster for a game controller of claim 8 further wherein the bridge is generally flat.

10. The holster for a game controller of claim 1 further wherein the holster is comprised of a material that allows a slight resiliency in the holster.

11. The holster for a game controller of claim 10 further wherein the holster is made from a material selected from he group lightweight plastic, a resilient metal, and a laminate wood.

12. The holster for a game controller of claim 1 further wherein the game controller is wireless.

13. A holster for a game controller comprising:
a support surface adapted to be mountable to a surface;
opposing ends connected to the support surface, the opposing ends being connected by bridge, the opposing ends and bridge defining a game controller rest area; and
the distance between the opposite ends narrowing as the opposite ends extend away from the bridge, such that the game controller rest area removably secures the game controller between the opposing ends.

14. The holster for a game controller of claim 13 further wherein the support surface is adapted to be mountable to a surface by an adhesive secured to a lower surface of the support surface.

15. The holster for a game controller of claim 13 further wherein the support surface is adapted to be mountable to a surface by defining an aperture through which a screw can extend.

16. The holster for a game controller of claim 13 further wherein the game controller rest area accommodates the game controller between hand accommodating extensions on the game controller.

17. The holster for a game controller of claim 13 further including an inwardly protruding section on at least one of the opposite ends to further secure the game controller in the game controller rest area.

18. The holster for a game controller of claim 13 further wherein the holster defines a cord accommodating aperture in one of the opposing ends.

19. The holster for a game controller of claim 13 further wherein the bridge is defined by the shape of the game controller.

20. The holster for a game controller of claim 19 further wherein the bridge is generally flat.

21. The holster for a game controller of claim 13 further wherein the holster is comprised of a material that allows a slight resiliency in the holster.

22. The holster for a game controller of claim 21 further wherein the holster is made from a material selected from he group lightweight plastic, a resilient metal, and a laminate wood.

23. The holster for a game controller of claim 13 further wherein the game controller is wireless.

24. A holster for a game controller comprising:
a support surface adapted to be mountable to a surface;
opposing ends connected to the support surface, the opposing ends being connected by bridge, the opposing ends and bridge defining a game controller rest area; and
an inwardly protruding section on at least one of the opposite ends such that the game controller rest area removably secures the game controller between the opposing ends.

25. The holster for a game controller of claim 24 further wherein the support surface is adapted to be mountable to a surface by an adhesive secured to a lower surface of the support surface.

26. The holster for a game controller of claim 24 further wherein the support surface is adapted to be mountable to a surface by defining an aperture through which a screw can extend.

27. The holster for a game controller of claim 24 further wherein the game controller rest area accommodates the game controller between hand accommodating extensions on the game controller.

28. The holster for a game controller of claim 24 further wherein the distance between the opposite ends narrow as the opposite ends extend away from the bridge to further secure the game controller in the game controller rest area.

29. The holster for a game controller of claim 24 further wherein the holster defines a cord accommodating aperture in one of the opposing ends.

30. The holster for a game controller of claim 24 further wherein the bridge is defined by the shape of the game controller.

31. The holster for a game controller of claim 30 further wherein the bridge is generally flat.

32. The holster for a game controller of claim 24 further wherein the holster is comprised of a material that allows a slight resiliency in the holster.

33. The holster for a game controller of claim 32 further wherein the holster is made from a material selected from he group lightweight plastic, a resilient metal, and a laminate wood.

34. The holster for a game controller of claim 24 further wherein the game controller is wireless.
